(19) United States
(12) Patent Application Publication
(10) Pub. No.: US 2004/0040016 A1
(43) Pub. Date: Feb. 26, 2004

(54) Method and system for providing a command-line interface syntax from an XML specification

(76) Inventors: Andrew Pearce, Cambridge (GB); Luke Diamand, Cambridge (GB)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/446,777

(22) Filed: Oct. 14, 2003

Related U.S. Application Data
(60) Provisional application No. 60/319,273, filed on May 29, 2002.

(51) Int. Cl. G06F 9/45

(52) U.S. Cl. 717/141

(57) ABSTRACT

A method and system is provided for making it convenient to alter the syntax of the command-line interface, or re-write it from scratch, without resorting to the alteration of source code. This reduces the level of skill required to make these changes, and also reduces the time and effort required. In particular, the present application provides for a method and system for defining an interface syntax using the high-level generic markup language XML (eXtensible Markup Language). Since XML is a simple language it is easier and less time-consuming to edit an existing syntax or write a new one from scratch. Initially, a CLI specification is defined in XML. Subsequently, the XML CLI is translated into source code as part of a compilation process. When compiled, the translated source code can initialize data structures to be read by a parser (whose code is fixed) to thereby implement the syntax defined initially in XML.

### CROSS-REFERENCE TO RELATED APPLICATIONS

The present application is a non-provisional of co-pending U.S. Provisional Patent Application No. 60/319,273, filed on May 29, 2002, the entirety of which is incorporated by reference herein.

### BACKGROUND OF THE INVENTION

The present invention relates generally to systems for controlling embedded devices and, more particularly, to systems and methods for providing adaptable and configurable command-line interfaces to such devices.

The command-line interface or ‘CLI’ is the primary user interface used for configuring, monitoring, and maintaining devices having embedded operating systems. Unlike personal computers or other systems running general operating systems (e.g., Microsoft Windows), embedded systems such as network switches and routers operate using a more specific embedded operating systems. Further unlike such general systems, embedded systems are typically provided with minimal user interface capabilities, since the majority of functions performed by the device are pre-configured during device assembly. However, in order to provide some degree of adaptability, some embedded devices may include a CLI for receiving and responding to user requests. These user interfaces allow users to directly and simply execute commands, whether using a connected console or terminal, or using remote access methods, such as TELNET.

In general, most CLI's are DOS-like interfaces in which each input command has a command name followed by a string of parameters. Further, a CLI may have a variety of “looks and feels”, which are generally defined by the various commands required to interact with the system and the format of the output from the system. Unfortunately, specifying these commands typically involves changing source code or other relatively low-level definitions within the system itself. This means that a relatively high degree of skill is required to specify a relatively simple interface. Further, changes or additions to the interface will also require such high level changes, which can result in both time consuming and costly revisions.

Accordingly, there is a need in the are of embedded systems command-line interfaces for a system and method for enabling CLI specification in a time-efficient and simple manner, and also requiring a significantly reduced skill level.

### BRIEF SUMMARY OF THE INVENTION

The present invention overcomes the problems noted above, and provides additional advantages, by providing a method and system for making it convenient to alter the syntax of the command-line interface, or re-write it from scratch, without resorting to the alteration of source code. This reduces the level of skill required to make these changes, and also reduces the time and effort required. In particular, the present application provides for a method and system for defining an interface syntax using the high-level generic markup language XML (eXtensible Markup Language). Since XML is a simple language it is easier and less time-consuming to edit an existing syntax or write a new one from scratch.

In one embodiment of the present invention, a CLI specification is initially defined in XML. Subsequently, the XML CLI is translated into source code as part of a compilation process. When compiled, the translated source code can initialize data structures to be read by a parser (whose code is fixed) to thereby implement the syntax defined initially in XML. In an alternative embodiment, an XML CLI specification can be read by the target device and the data structures generated directly at run-time. In this manner, the XML specification is read into the device every time the device is started up. The downside of this embodiment is increased startup time of the device, however, such an embodiment may prove more convenient if the defined syntax is likely to be altered more often or if a compiling is absent from the device.

### BRIEF DESCRIPTION OF THE DRAWINGS

The present invention can be understood more completely by reading the following Detailed Description of the Preferred Embodiments, in conjunction with the accompanying drawing.

FIG. 1 is a flow diagram illustrating one method for providing a command-line interface in accordance with the present invention.

FIG. 2 is a flow diagram illustrating one embodiment of a method for defining the command line syntax of step 100.

FIG. 3 is a flow diagram illustrating one embodiment of a method for adding additional actions in accordance with the present invention.

FIG. 4 is a flow diagram illustrating one method for utilizing of an XML CLI specification produced in the manner set forth in FIGS. 1-3.

### DETAILED DESCRIPTION OF THE PREFERRED EMBODIMENTS

The description below covers a method of converting an XML command-line interface specification into source code at compile-time—as noted above, it would also be possible to parse the XML at run-time to save compilation complexity and potentially increase flexibility, at the expense of increasing startup time of the target hardware.

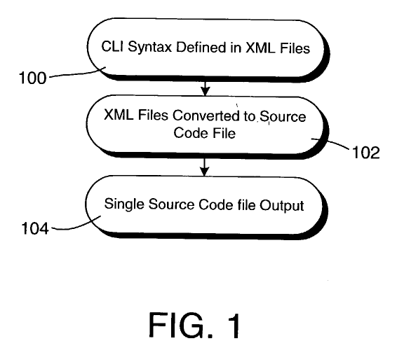

Referring to the Figures and, in particular, to FIG. 1, there is shown a flow diagram illustrating one method for providing a command-line interface in accordance with the present invention. Initially, in step 100, a command-line interface syntax is defined in a series of XML and related files, using a pre-defined syntax. Additional details regarding file content and syntax are set forth in additional detail below. Next, in step 102, each file in the group is read by a translation program which outputs a single source code file (in the C or C++ language, for example) in step 104.

In a preferred embodiment, the CLI code is auto-generated by a cli_parser script as part of the compilation process 102 during device boot-up. This script reads in XML specifications of the CLI grammar and outputs C code containing a list of action functions, for use by a parser, and a function to build appropriate parse trees. The parser then utilizes the code in responding to user-input commands.

By providing the CLI in a series of XML files, it is easily possible to exclude groups of commands within the syntax from the finished interface by removing appropriate XML files from the list of files to be translated. The following code section represents one illustration of an example XML CLI specification file:

<?xml version=“1.0” standalone=“yes”?>

<!DOCTYPE clispec SYSTEM “clispec.dtd”>

<clispec>

<keyword id=“_dest_ip_addr_” type=“V4IpAddr”/>

<keyword id=“_src_ip_addr_” type=“V4IpAddr”/>

<keyword id=“_ipaddr_” type=“V4IpAddr”/>

<keyword id=“_netmask_” type=“V4IpAddr”/>

<keyword id=“_name_” type=“String”/>

<keyword id=“_vci_” type=“Integer”/>

.

.

<command>

<syntax>ip set interface _name_ipaddress _ipaddr_</syntax>

<user>engineer</user>

<user>developer</user>

<action id=“set”>

<param name=“name0” value=“_name”/>

<param name=“type0” value=“ImIpInterface”/>

<param name=“attribute” value=“ipaddr”/>

<param name=“value” value=“_ipaddr_”/>

</action>

<code>

//Can insert arbitrary C/C++ code here

</code>

</command>

.

.

<node id=“ip”>

<summary>Commands to configure the router</summary>

</node>

<node id=“ip set”>

<summary>Commands to set attributes within the router</summary>

</node>

<node id=“ip set interface”>

<summary>Commands to set attributes of IP interfaces</summary>

</node>

.

. </clispec>

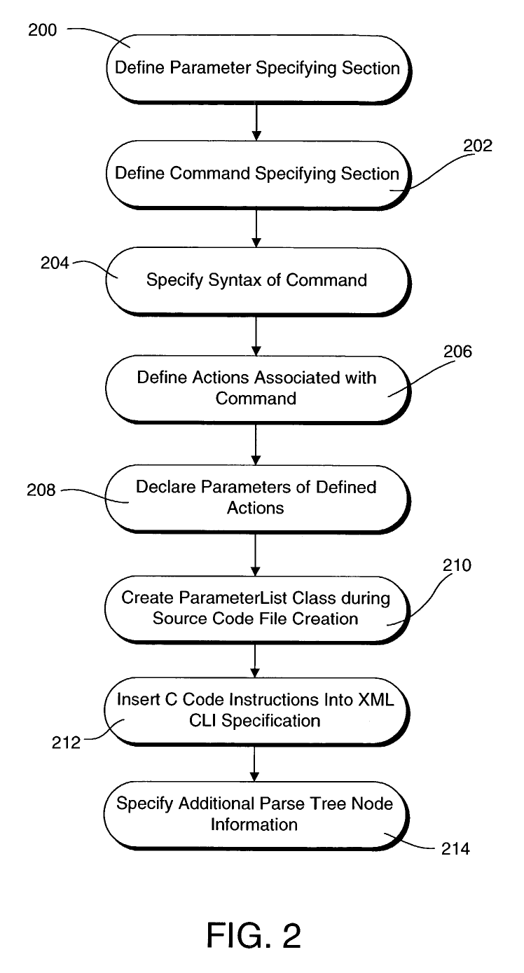

Referring now to FIG. 2, there is shown a flow diagram illustrating one embodiment of a method for defining the command line syntax of step 100. As can be seen from the above examplte, the XML CLI specification file is split into three discrete sections. A first section is defined in step 200 and serves to specify a set of parameter specifiers. These are arbitrary strings which are taken to represent parameters in the commands which are then further defined later in the file. As well as the string itself these parameter lines also specify a type for each parameter defined, which must be from a fixed list of supported types. This allows some basic checking of the values entered on the command line.

In step 202, a second section in the CLI specification file is provided for specifying the commands themselves which are defined in the CLI. Each command automatically checks that the correct number of arguments has been supplied, and will fail with an appropriate message to the user if appropriate arguments are not supplied. Some commands may require arbitrary lists of arguments, however, so this behavior can be disabled by modifying the command directive to:

<command extraargs=“true”>

In defining CLI commands, the syntax of the command is initially specified in step 204. In the syntax string any token which isn't a parameter specifier (as defined earlier in the first section of the CLI specification) is taken to be a keyword—i.e. a string which must match exactly on the command line. In a preferred embodiment, the parsing engine matches all non-keyword tokens in the same way irrespective of type. This means that the first difference between two commands must be in a keyword token. For example, it is not valid to have two unique commands specified as:

ip set interface <iface> <ipaddress>

and

ip set interface <iface> <mtu>

because during command parsing it is not possible to distinguish between an arbitrary integer and an arbitrary IP address. The only way to implement the above syntax would be to have the action function perform any necessary parsing after the interface name, and declare a single variable to represent both of the above options (ipaddress and mtu). Following the syntax definition in the command section is a set of level declarations. The level declarations specify the levels of user access to which the defined command is available.

The actions to be taken upon execution of a defined command are then specified in step 206 in the order in which they are to be performed and are identified by name. The current scheme assumes that a function of the form action_foo should be called to carry out the action called “foo”. Further, a list of parameters can be declared within each action specifier introduced in step 208. If any of the value strings match one of the parameter specifiers defined earlier in the first section, the appropriate token from the command line will be substituted in its place. Otherwise the string specified will be passed on as a verbatim string.

An action in this context is a single function that has been implemented in a source file. Each action has an associated textual name and this is used to refer to the action within the XML CLI specification. Each action can take a list of parameters, specified as name/value pairs—all these values are stored as strings. Due to the scheme of parsing the CLI specification during a compilation phase, actions can simply be specified as functions with names of the form action_set( ). The compilation process will automatically generate a function associated with each CLI command and these will call the action functions directly.

Next, in step 210, a class called ParameterList is set up to store the list of name/value pairs that make up the parameters. In one embodiment, this is created by the auto-generated functions and filled with the appropriate values either specified in the XML file or extracted from the command line. The ParameterList class has a simple interface to obtain the values of various parameters—actions can call a method get Parameter as follows:

const char*value=paramList→getParameter(“ipaddr”)

In this manner, parameter values for actions may be easily obtained.

The following description recites a plurality of exemplary actions which may be included in commands defined in an XML CLI specification, however, these actions should not be viewed as limitations to the present invention, since additional actions may be defined and utilized as required.

The following actions relate generally to manipulation actions for setting attributes, adding and deleting nodes, etc. In particular, an “add” action creates a new node, whose name and type are specified by newname and newtype respectively. The newname parameter is optional. The node specified is used as the parent for adding the node to the tree. Additionally a set of parameters of the form attributex and valuex, which are used to set attributes of the newly created node. A “clear” action takes a node specification and deletes all children of that node. A “delete” action takes a node specification and deletes that node. A “get” action displays the value of the attribute specified by the parameter attribute of the specified node. A “list” action lists children of the specified node—this is included for debugging purposes. A “listall” action displays a complete report of the device state for debugging purposes. A “set” action sets the value of the attribute specified by the parameter attribute to the value specified by the parameter value for the specified node. A “set_multiple” action is similar to the “set” action, and takes a list of attribute triplets of the form cliattribute0, imattribute0, attrtype0. The action searches the list of arguments not parsed for tokens matching those specified by the cliattributex parameters. When one is found, the command-line argument following it is used as the new value for the attribute specified by the corresponding imattributex parameter. Use of this macro can cause confusion as the attribute names will not be tab-completed by the parser, so care should be used.

The following actions relate to transport manipulation actions. In particular, the CLI specification presents a somewhat abstracted version of the Information Model structure, where a layer 2 session, channel and service are all created and attached together in a single operation. The combination of these three objects is known as a transport. An “add_<service>” action creates a service, layer 2 session and channel and attaches them together. The types supported are listed below with the parameters that must be supplied:

ether—name, creator, description, port

frame_relay—name, creator, description, port, dlci

rfc1483—name, creator, description, rxvci, txvci, rxvpi, txvpi, port, mode

ppp_pvc—name, creator, description, rxvci, txvci, rxvpi, txvpi, listener, interface

ppp_svc—name, creator, description, listener, interface

pppoe_pvc—name, creator, description, rxvci, txvci, rxvpi, txvpi, listener, interface

pppoe_svc—name, creator, description, listener, interface

ppp_hdlc—name, creator, description, listener, interface

ipoa_pvc—name, creator, description, rxvci, txvci, rxvpi, txvpi

ipoa_svc—name, creator, description

An “attach_channel” action takes the name of a service and the txvci, rxvci, txvpi, rxvpi and port parameters. Further, the action creates an ATM channel with the specified attributes and attaches it to the specified service. This is used for creating new channels after a transport has initially been created. An “attach_service” action attaches the specified IP interface node to the transport given by the transportname parameter. A “clear_service” action is similar to the “clear” action described above, but takes a single parameter type and deletes all services of that type (and also performs any additional detaching required). A “detach_channels” action takes txvci, rxvci, txvpi, rxvpi and port parameters and destroys any channels on the specified service which match those attributes. A “detach_service” action treats the specified node as an IP interface and detaches any services attached to it.

In some cases the generic manipulation actions described above are not appropriate and specialized versions which operate differently are required. Examples of such actions are set forth below. An “add_user” action creates a new user with a name specified by the username attribute. A “set_autoprov” action takes a single parameter setting which should be either opendsl, autopvc or nothing. The current autoprovisioning scheme is set accordingly. A “set_password” action prompts the current user to set their password, then verifies it and sets the value in the Information Model if the two strings match. Note that this differs from other set methods in that it does not take the new value for the password as a parameter (to avoid the user having to display it on the screen). A “set_user” action changes the current effective user without prompting for a password. It should be understood that it is important to ensure that only a sufficiently privileged user has access to a command using this action.

Several actions are supported for saving the configuration. “Config_save” and “config_restore” actions save to and restore from the standard configuration.

“Config_save_backup” and “config_restore_backup” actions save to and restore from the backup configuration. A “config_restore_factory” action restores the system to factory defaults.

Regarding parsed output actions, the primary form of output is in the form of text files which contain macros to interrogate the state of the system and substitute values as appropriate. These are sent to the console using the actions listed below. A “display_macro” action displays the text file containing the associated macros specified by the url parameter to the console. A “display_node_macro” is similar to the “display_macro” action above, however, this also takes a node specification attribute. The path to this node is placed in the context's text buffer before the text file is displayed.

Regarding traditional console access (that is, non-web access), several actions exist to provide access to the traditional console. A “do_tell” action is provided for taking a list of parameters of the form tellargx, concatenating them together and using the traditional console to parse them with any specified blacklisting. A “do_cli_tell” is similar to the “do_tell” action, but takes the arguments for the tell message from the command-line. An “old_console” action causes the CLI to drop down to the traditional console.

Various actions are also provided for performing miscellaneous functions. In particular, the “calculate_netmask” action takes two parameters, addressattribute and netmaskattribute. If the attribute specified by netmaskattribute is not set, the attribute specified by addressattribute is treated as an IP address and its natural netmask is calculated. This is stored in the attribute referred to by netmaskattribute. A “check_enabled” action takes two parameters: attribute and message. If the specified attribute has the value false, then the specified message is displayed. This is typically used to remind the user that a service is not enabled if they change its configuration. An “enact” action calls the enact function on the specified node, which must conform to the ImEnactable interface. A “list_ports” action lists all the Ethernet ports in the system. A “logout” action logs the current user out, killing their TELNET connection if applicable. A “reboot” action causes a reboot. A “trace” action sets the trace level, as specified by the level attribute which should be one of LogLevelNone, LogLevelWarning, LogLevelInfo, LogLevelTrace, LogLevelEntryExitTrace or LogLevelAll.

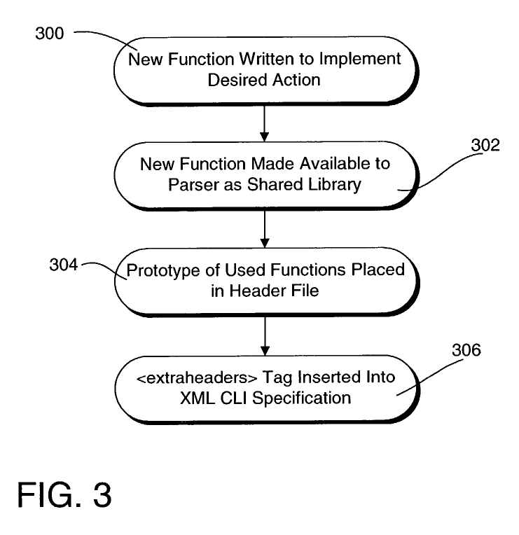

In addition to the identified and supported actions described above, the present inventions provides increased flexibility by enabling the addition of new actions. Referring now to FIG. 3, there is shown a flow diagram illustrating one embodiment of a method for adding additional actions in accordance with the present invention. In step 300, a new function is written to implement the desired action. Next, in step 302, the new function is made available to the parser as a shared library. Prototypes for all the functions used should then be placed in a header file as usual in step 304. In step 306, an <extraheaders> tag is inserted into the XML CLI specification files to include these header files in the output code—anything between this and its matching closing tag will be placed in the auto-generated include file. It should be noted that any other elements which are needed to support C code fragments which are to be included in the output files should also be placed in the <extraheaders> tag. The paths to these include files must then be manually inserted into the CLI's specification file.

It is also possible to include arbitrary C/C++ code in the auto-generated functions. This can be useful for small or specialized tasks where the work of writing a new action is not justified. Any code can be included, though it is still built as part of the overall process so all functions accessed must either be part of the same process or built as a shared library. Any headers required can be included using the <extraheaders> tag as described above.

Returning now to FIG. 2, any desired C code commands or instructions may be inserted in step 212. This is preferably accomplished through the use of a <code> tag to include the C code for a CLI command. The <code> tag has no attributes and can be used anywhere where an <action> tag is used. Any code placed between this tag and its closing tag is included in the function associated with that CLI command. Actions and code sections can be mixed arbitrarily and are always included in the order they occur in the XML file. As one optimization of the present invention, if a CLI command only contains code sections and no actions, much of the initialization code is skipped for that command. This includes gaining a lock on the Information Model, so the code may potentially have to acquire a lock itself if it wishes to access the Information Model.

A third section of the CLI specification file is defined in step 214 and specifies any additional information about the nodes in the parse tree that is required. In the above embodiment, this information consists of summary help for each node, generally describing the function associated with each node. In one embodiment of the present invention, the summary is a string listed with a token when it is presented as a possible completion of a command.

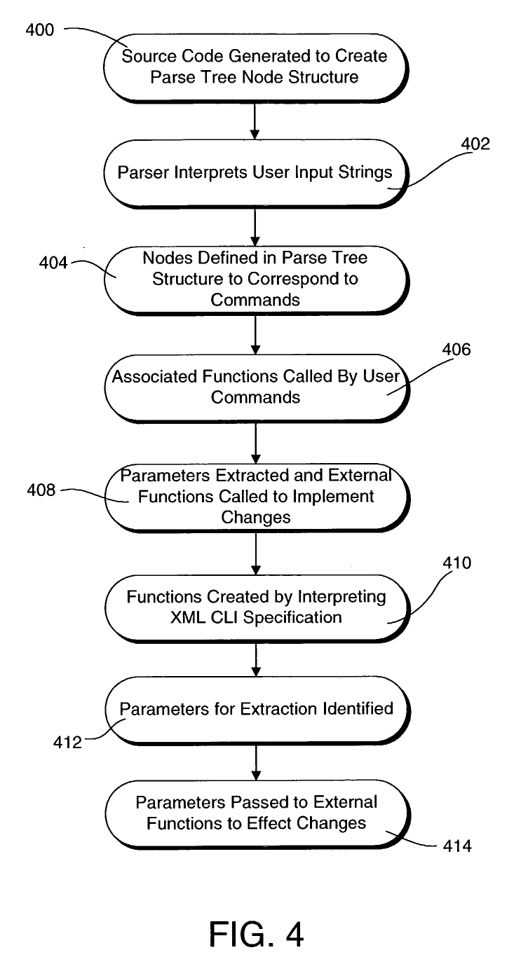

Referring now to FIG. 4, there is shown a flow diagram illustrating one method for utilizing of an XML CLI specification produced in the manner set forth above in FIGS. 1-3. Initially, in step 400, source code generated in the manner described above is compiled to creating a parse-tree data structure in memory on the target hardware. In step 402, a parser, whose implementation is fixed (i.e. is not generated as part of the compile process), then interprets the strings entered by the user by traversing the created parse-tree structure. Further, in step 404, nodes are defined within the parse-tree structure corresponding to valid commands have a function associated. These functions are then called when a user enters the associated command at the interface in step 406. These functions contain code to extract any required parameters from the input string and call into more general functions to actually implement configuration changes on the target hardware in step 408. The translation program creates these functions by interpreting the list of actions specified in the XML file in step 410. Further, the translation program determines, in step 412, which arguments need to be extracted from the string entered by the user and passes them into calls to the appropriate external functions to effect the changes in step 414. The external functions take the form of a fixed external API (applications programming interface) which is defined independently and is outside the scope of the present invention.

In accordance with one embodiment of the present invention, commands may be defined in terms of user access. Accordingly, separate parse-trees may be generated for each user of the system. Therefore, each user only observes commands to which they have access.

As is understood in the art, each series of XML files requires at least an associated document type definition (DTD) which defines the legal building blocks of an XML document. The DTD defines the document structure with a list of legal elements. A DTD can be declared inline in the XML document, or as an external reference typically having a .dtd extension which is referenced by the associated XML file. One embodiment of a DTD file supporting the present invention is shown below although any actual DTD files would include elements specifically related to its associated XML file.

<!ELEMENT clispec (scriptversion?,

extraheaders?,

alias?,

keyword*,

command*,

node*)>

<!ELEMENT scriptversion (#PCDATA)>

<!ELEMENT extraheaders (#PCDATA)>

<!ELEMENT alias EMPTY>

<!ATTLIST alias from CDATA #REQUIRED>

<!ATTLIST alias to CDATA #REQUIRED>

<!ELEMENT keyword EMPTY>

<!ATTLIST keyword id CDATA #REQUIRED>

<!ATTLIST keyword type CDATA #REQUIRED>

<!ELEMENT command (syntax,

user*,

(action|code)*)>

<!ATTLIST command extraargs (true|false) “false”>

<!ELEMENT syntax (#PCDATA)>

<!ELEMENT user (#PCDATA)>

<!ELEMENT action (param*)>

<!ATTLIST action id CDATA #REQUIRED>

<!ELEMENT code (#PCDATA)>

<!ELEMENT param (#PCDATA)>

<!ATTLIST param name CDATA #REQUIRED>

<!ATTLIST param value CDATA #REQUIRED>

<!ELEMENT node (summary?)>

<!ATTLIST node id CDATA #REQUIRED>

<!ELEMENT summary (#PCDATA)>

Additionally, a templates file is also preferably included within the series of XML files for including code which is used to build up the output source code files by substituting in strings into the CLI specification file. Preferred embodiments of both an XML CLI specification file as well as a template file are provided in Appendixes A and B, respectively.

By providing the capability for easily and quickly defining and implementing a new or modified CLI, changes to an existing interface may be made at a substantially reduced cost in terms of both time and money. While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A method for providing a command-line interface syntax from an XML specification for an embedded device, comprising the steps of:
defining the command-line interface syntax in at least one XML file;
translating the at least one XML file to generate a source code file based upon the at least one XML file; and
outputting the source code file for use by a parser responsive to user input commands.

2. The method of claim 1, wherein the step of translating the at least one XML file to generate the source code file is automatically performed by a cli_parser script during device boot-up.

3. The method of claim 1, wherein the step of defining the command-line interface syntax in at least one XML file, further comprises the steps of:
defining a parameter specifying section, wherein at least one command parameter is defined;
defining a command specifying section, wherein at least one command is defined; and
defining a parse tree node information section.

4. The method of claim 3, wherein the step of defining a command specifying section, further comprises the steps of:
defining a syntax of the at least one command, wherein the syntax includes syntax string and parameter specifiers;
defining at least one action associated with the at least one command, wherein the action includes a name and at least one parameter.

5. The method of claim 4, further comprising the step of defining at least one user having access to the at least one command.

6. The method of claim 4, further comprising the steps of:
defining a new function to implement a desired action;
placing a prototype for the new function into a header file; and
inserting a tag into the at least one XML file referencing the new function prototype in the header file.

7. The method of claim 4, further comprising the step of inserting source code instructions into the at least one XML file relating to the at least one action.

8. The method of claim 3, wherein the step of defining a parse tree node information section, further comprises the steps of:
defining summary help information for each node.

9. The method of claim 1, further comprising the steps of:
compiling the source code file to generate a parse tree data structure in memory on the embedded device;
interpreting user input strings by a parser, wherein interpretation includes traversing the parse tree structure;
defining nodes within the parse tree structure corresponding to available commands;
calling functions associated with an input command; and
implementing associated configuration changes on the embedded device.

10. A computer-readable medium incorporating instructions for providing a command-line interface syntax from an XML specification for an embedded device, comprising:
one or more instructions for defining the command-line interface syntax in at least one XML file;
translating the at least one XML file to generate a source code file based upon the at least one XML file; and
outputting the source code file for use by a parser responsive to user input commands.

11. The computer-readable medium of claim 10, wherein the one or more instructions for translating the at least one XML file to generate the source code file are automatically performed by a cli_parser script during device boot-up.

12. The computer-readable medium of claim 10, wherein the one or more instructions for defining the command-line interface syntax in at least one XML file, further comprise:
one or more instructions for defining a parameter specifying section, wherein at least one command parameter is defined;
one or more instructions for defining a command specifying section, wherein at least one command is defined; and
one or more instructions for defining a parse tree node information section.

13. The computer-readable medium of claim 12, wherein the one or more instructions for defining a command specifying section, further comprise:
one or more instructions for defining a syntax of the at least one command, wherein the syntax includes syntax string and parameter specifiers;
one or more instructions for defining at least one action associated with the at least one command, wherein the action includes a name and at least one parameter.

14. The computer-readable medium of claim 13, the instructions further comprising one or more instructions for defining at least one user having access to the at least one command.

15. The computer-readable medium of claim 13, the instructions further comprising:
one or more instructions for defining a new function to implement a desired action;
one or more instructions for placing a prototype for the new function into a header file; and
one or more instructions for inserting a tag into the at least one XML file referencing the new function prototype in the header file.

16. The computer-readable medium of claim 13, further comprising one or more instructions for inserting source code instructions into the at least one XML file relating to the at least one action.

17. The computer-readable medium of claim 12, wherein the one or more instructions for defining a parse tree node information section, further comprise:
one or more instructions for defining summary help information for each node.

18. The computer-readable medium of claim 10, further comprising:
one or more instructions for compiling the source code file to generate a parse tree data structure in memory on the embedded device;
one or more instructions for interpreting user input strings by a parser, wherein interpretation includes traversing the parse tree structure;
one or more instructions for defining nodes within the parse tree structure corresponding to available commands;
one or more instructions for calling functions associated with an input command; and
one or more instructions for implementing associated configuration changes on the embedded device.
